(19) United States
(12) Patent Application Publication
(10) Pub. No.: US 2019/0080244 A1
(43) Pub. Date: Mar. 14, 2019

(54) SCHEDULING METHOD AND SYSTEM BASED ON IMPROVED VARIABLE NEIGHBORHOOD SEARCH AND DIFFERENTIAL EVOLUTION ALGORITHM

(71) Applicant: Hefei University of Technology, Hefei (CN)

(72) Inventors: Jun PEI, Hefei (CN); Qingru SONG, Hefei (CN); Xinbao LIU, Hefei (CN); Shaojun LU, Hefei (CN); Qiang ZHANG, Hefei (CN); Wenjuan FAN, Hefei (CN)

(21) Appl. No.: 16/127,361

(22) Filed: Sep. 11, 2018

(30) Foreign Application Priority Data
Sep. 11, 2017 (CN) 201710813160.1

(51) Int. Cl. G06N 3/12; G06F 7/58; G06Q 10/06

(52) U.S. Cl. CPC G06N 3/126; G06Q 10/06314; G06F 7/58

(57) ABSTRACT

The present invention relates to a production batch scheduling method and system based on improved variable neighborhood search and differential evolution algorithms as well as a storage medium. The method is executed by a computer, and includes: setting algorithm parameters; building a neighborhood structure; initializing a population; determining an initial solution; calculating a fitness value; locally searching; selecting a male parent; performing individual recessive variation; regenerating the population; updating the initial solution; updating a neighborhood structure of algorithmic search; and judging whether a terminal condition of algorithm execution is met, outputting a global optimal solution of the algorithmic search if so, otherwise, returning to Step 6. The present invention can obtain an approximate optimal solution in regard to a coordinated batch scheduling problem of production and transportation in the case of a manufacturer single machine based on a differential workpiece.

### CROSS-REFERENCE TO RELATED APPLICATIONS

This application claims to Chinese application no. 201710813160.1 with a filing date of Sep. 11, 2017. The content of the aforementioned application, including any intervening amendments thereto, are incorporated herein by reference.

### TECHNICAL FIELD

The present invention relates to the technical field of software, and particularly relates to a production batch scheduling method and system based on improved variable neighborhood search and differential evolution algorithms as well as a computer readable storage medium.

### BACKGROUND OF THE PRESENT INVENTION

A problem of resource allocation has always been a focus of the society, while a production batch scheduling problem is a type of typical combinational optimization problem, and stems from a chip testing stage at the earliest. Inspired by the actual problem, the batch scheduling problem becomes a hot subject of a study. A batch scheduling theory is widely used in actual industries, such as: logistics transportation, heavy metal manufacturing industry and other fields. In the batch scheduling problem, a plurality of production tasks can use the same processing resource at the same time, and the production tasks in an actual production process are restrained by several conditions. When a current production restraint condition is met, design of a scientific and reasonable production scheduling scheme could standardize a production management level of the enterprise and improve the production efficiency of the enterprise, thereby enabling the enterprise to improve the core competitiveness in a market that a buyer becomes a mainstream nowadays. Thus it can be seen that, study on the batch scheduling problem has a significant practical significance in operation management of both the enterprise and the whole society.

By synthesizing the existing research results, most of batch scheduling problems are an NP hard problem. Therefore, an intelligent algorithm is generally used to seek an approximate optimal scheduling scheme when solving such combinational optimization problem. A research method studies the batch scheduling problem of a single machine, considers different sizes and processing times of workpieces, and designs a discrete particle swarm algorithm for solving such problem. One method is to design a free search algorithm and a hybrid neighborhood search algorithm with regard to the same problem respectively; and another method is to solve such problem based on an ant colony algorithm.

However, during invention and creation, the inventor finds that, the existing art has the following defects: (1) for a research problem, consideration is mainly given from workpiece restraint in the study on the batch scheduling problem of the single machine in previous literatures, such as a size, a processing time and an arrival time of the workpiece, and the research model of the literatures is mainly concentrated on a production stage, and the study on coordinated batch scheduling of production and transportation is few. In an actual environment, because the production and transportation are key factors that decide the customer satisfaction level, the enterprise not only considers improving the production efficiency at the production stage, but also considering the benefit at a transportation stage. (2) For the research method, the factors, such as quality of an initial solution, a neighborhood structure and a search strategy in the neighborhood structure, affect the performance of a variable neighborhood search algorithm.

### SUMMARY OF THE PRESENT INVENTION

The present invention provides a production batch scheduling method and system based on improved variable neighborhood search and differential evolution algorithms as well as a computer readable storage medium, so as to solve at least one of the above technical problems.

In a first aspect, an embodiment of the present invention provides a production batch scheduling method based on improved variable neighborhood search and differential evolution algorithms. The method is executed by a computer, and includes:

S1. initializing an input parameter of an algorithm, including number n of workpieces, workpiece size s, a basic processing time p of the workpieces, an arrival time r of the workpieces, capacity C of a processing machine, and a time T of transporting the workpieces from a manufacturer to a customer. A set of processing workpieces is marked as J={J₁, . . . , Jᵢ, . . . , Jₙ}, wherein Jᵢ indicates the i-th workpiece;

S2. setting an execution parameter of the algorithm, wherein the execution parameter includes a maximum number of iterations Iₘₐₓ, a current number of iterations I−1, a population size Q, an initial solution Xₛ of the algorithm, number top of outstanding individuals in a population, and a global optimal solution X_{best}=Xₛ;

S3. setting a neighborhood structure N_{K} (X), wherein X indicates the initial solution, and K indicates a kind of the neighborhood structure. In consideration of three neighborhood structures, when K=1, it indicates variable neighborhood structure; when K=2, it indicates a cross neighborhood structure; and when K=3, it indicates an insertion neighborhood structure;

S4. initializing a population individual set S in a local search; and considering Q individuals totally, wherein the j-th individual in the I-th generation of populations is defined as Xⱼ^{I}={xⱼ₁^{I}, xⱼ₂^{I}, . . . , x_{jd}^{I}, . . . , xⱼₙ^{I}}, 1I≤I≤iₘₐₓ, j=1,2, . . . , Q and d=1,2, . . . , n, wherein x_{jd}^{I}∈[1, n], indicating the x_{jd}^{I}-th workpiece in the workpiece set in the d-th position of the individual Xⱼ^{I};

S5. generating three initial individuals with three heuristic algorithms respectively, taking the initial solution as three individuals in the initial population, randomly generating the remaining individuals in the initial population, and selecting an optimal individual from the initial population as the initial solution;

S6. selecting the neighborhood structure, defining the initial solution Xₛ^{N} of the neighborhood structure, and performing a local search strategy to the individuals in the population in the neighborhood structure, to improve the quality of the population individuals;

S7. calculating a fitness value of each individual in the population respectively, thereby obtaining an individual X_{local} having the minimum fitness value from the population;

S8. updating the global optimal solution of the algorithm, judging whether F(X_{local})<F(X_{best}) is satisfied, and assigning X_{local} to X_{best} if so, wherein F(X) indicates the fitness value of the individual X;

S9. updating the initial solution, judging whether F(X_{local})<F(X_{S}) is satisfied, and assigning X_{local} to Xₛ if so;

S10. updating the initial solution of the neighborhood structure, judging whether F(X_{local})<F(Xₛ^{N}) is satisfied, and assigning X_{local} to Xₛ^{N} if so;

S11. assigning I+1 to I, judging whether I≤Iₘₐₓ is satisfied, performing step S12 if so, otherwise, performing step S13;

S12. judging whether Xₛ^{N} is updated, returning to step S6 if so, otherwise, assigning K+1 to K; and if K>3, setting K=1, and returning to step S6; and

S13. completing the execution of the algorithm and outputting the fitness value of the global optimal solution X_{best} and a group batching scheme corresponding to the workpiece,

wherein the step of performing a local search strategy to the individuals in the population in the neighborhood structure in step S6 includes:

step S61′: defining that a variable Sₜₒₚ^{I} indicates the individual with top quality of the stored population, Nₒₜₕₑᵣ indicates the number of other remaining individuals of the population S^{I}, Sₗₑₐₛₜ^{I} indicates a set of other remaining individuals of the stored population S^{I}, N_{c}, indicates the number of variation individuals, Nᵣ indicates the number of random individuals, and Sᵣ^{I} indicates a set of the stored random individuals;

step S62′: with regard to the population S^{I-1}, assigning the individual with top fitness in the population to Sₜₒₚ^{I}, and assigning the remaining individuals to Sₗₑₐₛₜ^{I};

step S63′: taking a remainder obtained by dividing the number of iterations I by Nₒₜₕₑᵣ, assigning the remainder to N_{c}, and setting N_{c}=1 if N_{c}=0;

step S64′: selecting an individual from Sₗₑₐₛₜ^{I} randomly, generating two positions rand1 and rand2 randomly with regard to the individual, and rand1≠rand2, and performing symmetric exchange processing to an element of the individual between the two positions;

step S65′: repeating step S64′, until selecting N_{c} different individuals for corresponding variation operation;

step S66′: judging whether the current generation of neighborhood structure is the same as that of the previous generation, generating Nᵣ individuals randomly if so, and storing in S^{r}, otherwise, performing step S67′;

step S67′: randomly selecting two elements in the initial solution Xₛ^{N} of the neighborhood structure, exchanging the two elements to generate a new individual, repeating such operation until generating Nᵣ individuals, and storing the individuals in S^{r}; and

step S68′: assigning all individuals in Sₜₒₚ^{I}, S^{c} and S^{r} to S^{I} respectively, as the regenerated population of this generation,

wherein the step of generating three initial individuals with three heuristic algorithms respectively, taking the initial solution as three individuals in the initial population, randomly generating the remaining individuals in the initial population, and selecting an optimal individual from the initial population as the initial solution in step S5 includes:

step S51: defining a variable j=1;

step S52: judging a value of the variable j, and performing step S53 when the value is equal to 1; performing step S54 when the value is equal to 2; performing step S55 when the value is equal to 3; and performing step S56 when the variable has other values;

step S53: sorting all workpieces in the workpiece set J−{J₁, . . . , Jᵢ, . . . , Jₙ} according to the arrival times thereof in a non-decreasing manner, and taking the sorted workpiece set J′ as the individual Xⱼ¹ in the initial population;

step S54: sorting all workpieces in the workpiece set J={J₁, . . . , Jᵢ, . . . , Jₙ} according to the processing times thereof in a non-decreasing manner, and taking the sorted workpiece set J′ as the individual Xⱼ¹ in the initial population;

step S55: sorting all workpieces in the workpiece set J={J₁, . . . , Jᵢ, . . . , Jₙ} according to the processing times thereof in a non-increasing manner, and taking the sorted workpiece set J′ as the individual Xⱼ¹ in the initial population;

step S56: sorting all workpieces in the workpiece set J={J₁, . . . , Jᵢ, . . . , Jₙ} randomly, and taking the sorted workpiece set J′ as the individual Xⱼ¹ in the initial population;

step S57: assigning j+1 to j, judging whether j≤Q is satisfied, returning to step S52 if so, otherwise, completing the population initialization; and

step S58: selecting the individual having the best quality according to the initial population, and assigning the individual to the initial solution Xₛ,

wherein the step of calculating the fitness value of the individual in step S7 includes:

step S71: placing the first undistributed workpiece in a workpiece sequence of the individual X in the first existing batch capable of accommodating the workpiece, creating a new batch with a capacity of C if each existing batch cannot accommodate the workpiece, and placing the workpiece in the new batch;

step S72: repeating step S71, until all workpieces in the individual X are distributed to the corresponding batch, and obtaining a workpiece batch set B={B₁, . . . , Bᵢ, . . . , Bₗ}, wherein l indicates the number of the batches;

step S73: sorting the workpiece batches in the batch set obtained in step S72 according to the arrival times of the workpiece batches in a non-decreasing manner, and obtaining a sorted batch set B′={B′₁, . . . , B′ᵢ, . . . , B′ₗ}, wherein B′ᵢ indicates the workpiece batch processed in the l-th position in a processing machine;

step S74: defining a variable Cₘₐₓ=0, which indicates a time required by a manufacturing span, circulating a variable j=1, and marking the processing time of the workpiece batch B′ᵢin the batch set B′ as Pᵢ^{B′} and the arrival time as rᵢ^{B′};

step S75: judging whether the current Cₘₐₓ≤rⱼ^{B′} is satisfied, assigning rⱼ^{B′}|Pⱼ^{B′} to Cₘₐₓ if so, otherwise, assigning Cₘₐₓ+Pⱼ^{B′} to Cₘₐₓ;

step S76: assigning j+1 to j, judging whether j≤1 is satisfied, returning to step S75 if so, otherwise, assigning Cₘₐₓ+T to Cₘₐₓ; and

step S77: taking Cₘₐₓ value finally obtained in step S76 as the fitness value of the individual X.

In a second aspect, an embodiment of the present invention provides a production batch scheduling system based on improved variable neighborhood search and differential evolution algorithms. The scheduling system includes a computer, and the computer includes:

at least one storage unit;

at least one processing unit; and

at least one output unit,

wherein the at least one storage unit stores at least one instruction, and the at least one instruction is loaded and executed by the at least one processing unit to realize the following steps:

S1. initializing an input parameter of an algorithm, including number n of workpieces, workpiece size s a basic processing time p of the workpieces, an arrival time r of the workpieces, capacity C of a processing machine, and a time T of transporting the workpieces from a manufacturer to a customer. A set of processing workpieces is marked as J={J₁, . . . , Jᵢ, . . . , Jₙ}, wherein Jᵢ indicates the i-th workpiece;

S2. setting an execution parameter of the algorithm, wherein the execution parameter includes a maximum number of iterations Iₘₐₓ, a current number of iterations I=1, a population size Q, an initial solution Xₛ of the algorithm, number top of outstanding individuals in a population, and a global optimal solution X_{best}=Xₛ;

S3. setting a neighborhood structure N_{K}(X), wherein X indicates the initial solution, and K indicates a kind of the neighborhood structure. In consideration of three neighborhood structures, when K=1, it indicates variable neighborhood structure; when K=2, it indicates a cross neighborhood structure; and when K=3, it indicates an insertion neighborhood structure;

S4. initializing a population individual set S in a local search; and considering Q individuals totally, wherein the j-th individual in the I-th generation of populations is defined as Xⱼ^{I}={xⱼ₁^{I}, xⱼ₂^{I}, . . . , x_{jd}^{I}, . . . , xⱼₙ^{I}}, 1≤I≤Iₘₐₓ, j=1,2, . . . , Q and d=1,2, . . . , n, wherein x_{jd}^{I}∈[1, n], indicating the x_{jd}^{I}-th workpiece in the workpiece set in the d-th position of the individual Xⱼ^{I};

S5. generating three initial individuals with three heuristic algorithms respectively, taking the initial solution as three individuals in the initial population, randomly generating the remaining individuals in the initial population, and selecting an optimal individual from the initial population as the initial solution;

S6. selecting the neighborhood structure, defining the initial solution Xₛ^{N} of the neighborhood structure, and performing a local search strategy to the individuals in the population in the neighborhood structure, to improve the quality of the population individuals;

S7. calculating a fitness value of each individual in the population respectively, thereby obtaining an individual X_{local} having the minimum fitness value from the population;

S8. updating the global optimal solution of the algorithm, judging whether F(X_{local})<F(X_{best}) is satisfied, and assigning X_{local} to X_{best} if so, wherein F(X) indicates the fitness value of the individual X;

S9. updating the initial solution, judging whether F(X_{local})<F(Xₛ) is satisfied, and assigning X_{local} to Xₛ if so;

S10. updating the initial solution of the neighborhood structure, judging whether F(X_{local})<F(Xₛ^{N}) is satisfied, and assigning X_{local} to Xₛ^{N} if so;

S11. assigning I+1 to I, judging whether I≤Iₘₐₓ is satisfied, performing step S12 if so, otherwise, performing step S13;

S12. judging whether Xₛ^{N} is updated, returning to step S6 if so, otherwise, assigning K+1 to K; and if K>3, setting K=1, and returning to step S6; and

S13. completing the execution of the algorithm.

The at least one output unit is configured to output the fitness value of the global optimal solution X_{best} and a group batching scheme corresponding to the workpiece,

wherein the process of performing a local search strategy to the individuals in the population in the neighborhood structure in step S6, realized by loading and executing the at least one instruction by the at least one processing unit, includes:

step S61′: defining that a variable Sₜₒₚ^{I} indicates the individual with top quality of the stored population, Nₒₜₕₑᵣ indicates the number of other remaining individuals of the population S^{I}, Sₗₑₐₛₜ^{I} indicates a set of other remaining individuals of the stored population S^{I}, N_{c} indicates the number of variation individuals, Nᵣ indicates the number of random individuals, and Sᵣ^{I} indicates a set of the stored random individuals;

step S62′: with regard to the populations S^{I-1}, assigning the individual with top fitness in the population to Sₜₒₚ^{I}, and assigning the remaining individuals to Sₗₑₐₛₜ^{I};

step S63′: taking a remainder obtained by dividing the number of iterations I by Nₒₜₕₑᵣ assigning the remainder to N_{c}, and setting N_{c}=1 if N_{c}=0;

step S64′: selecting an individual from Sₗₑₐₛₜ^{I} randomly, generating two positions rand1 and rand2 randomly with regard to the individual, and rand1≠rand2, and performing symmetric exchange processing to an element of the individual between the two positions;

step S65′: repeating step S64′, until selecting N_{c} different individuals for corresponding variation operation;

step S66′: judging whether the current generation of neighborhood structure is the same as that of the previous generation, generating Nᵣ individuals randomly if so, and storing in S^{r}, otherwise, performing step S67′;

step S67′: randomly selecting two elements in the initial solution Xₛ^{N} of the neighborhood structure, exchanging the two elements to generate a new individual, repeating such operation until generating Nᵣ individuals, and storing the individuals in S^{r}; and

step S68′: assigning all individuals in Sₜₒₚ^{I}, S^{c} and S^{r} to S^{I} respectively, as the regenerated population of this generation,

wherein the step of generating three initial individuals with three heuristic algorithms respectively, taking the initial solution as three individuals in the initial population, randomly generating the remaining individuals in the initial population, and selecting an optimal individual from the initial population as the initial solution in step S5, realized by loading and executing the at least one instruction by the at least one processing unit, includes:

step S51: defining a variable j=1;

step S52: judging a value of the variable j, and performing step S53 when the value is equal to 1; performing step S54 when the value is equal to 2; performing step S55 when the value is equal to 3; and performing step S56 when the variable has other values;

step S53: sorting all workpieces in the workpiece set J={J₁, . . . , Jᵢ, . . . , Jₙ} according to the arrival times thereof in a non-decreasing manner, and taking the sorted workpiece set J′ as the individual Xⱼ¹ in the initial population;

step S54: sorting all workpieces in the workpiece set J={J₁, . . . , Jᵢ, . . . , Jₙ} according to the processing times thereof in a non-decreasing manner, and taking the sorted workpiece set J′ as the individual Xⱼ¹ in the initial population;

step S55: sorting all workpieces in the workpiece set J={J₁, . . . , Jᵢ, . . . , Jₙ} according to the processing times thereof in a non-increasing manner, and taking the sorted workpiece set J′ as the individual Xⱼ¹ in the initial population;

step S56: sorting all workpieces in the workpiece set J={J₁, . . . , Jᵢ, . . . , Jₙ} randomly, and taking the sorted workpiece set J′ as the individual Xⱼ¹ in the initial population;

step S57: assigning j+1 to j, judging whether j≤Q is satisfied, returning to step S52 if so, otherwise, completing the population initialization; and

step S58: selecting the individual having the best quality according to the initial population, and assigning the individual to the initial solution Xₛ,

wherein the process of calculating the fitness value of the individual in step S7, realized by loading and executing the at least one instruction by the at least one processing unit, includes:

step S71: placing the first undistributed workpiece in a workpiece sequence of the individual X in the first existing batch capable of accommodating the workpiece, creating a new batch with a capacity of C if each existing batch cannot accommodate the workpiece, and placing the workpiece in the new batch;

step S72: repeating step S71, until all workpieces in the individual X are distributed to the corresponding batch, and obtaining a workpiece batch set B={B₁, . . . , Bᵢ, . . . , Bₗ}, wherein l indicates the number of the batches;

step S73: sorting the workpiece batches in the batch set obtained in step S72 according to the arrival times of the workpiece batches in a non-decreasing manner, and obtaining a sorted batch set B′={B′₁, . . . , B′ᵢ, . . . , B′ₗ}, wherein B′ᵢ indicates the workpiece batch processed in the l-th position in a processing machine;

step S74: defining a variable Cₘₐₓ−0, which indicates a time required by a manufacturing span, circulating a variable j=1, and marking the processing time of the workpiece batch B′ᵢ in the batch set B′ as Pᵢ^{B′} and the arrival time as rᵢ^{B′};

step S75: judging whether the current Cₘₐₓ≤rⱼ^{B′} is satisfied, assigning rⱼ^{B′}+Pⱼ^{B′} to Cₘₐₓ if so, otherwise, assigning Cₘₐₓ+Pⱼ^{B′} to Cₘₐₓ;

step S76: assigning j+1 to j, judging whether j≤1 is satisfied, returning to step S75 if so, otherwise, assigning Cₘₐₓ+T to Cₘₐₓ; and

step S77: taking Cₘₐₓ value finally obtained in step S76 as the fitness value of the individual X.

In a third aspect, an embodiment of the present invention provides a computer readable storage medium. The storage medium stores at least one instruction which is loaded and executed by a processor to realize the above scheduling method.

The embodiments of the present invention can obtain the approximate optimal solution in regard to a coordinated batch scheduling problem of production and transportation in the case of a manufacturer single machine based on a differential workpiece, so that an enterprise can make full use of production resources to the greatest extent, thereby reducing the production cost and improving enterprise service level and customer satisfaction level.

### BRIEF DESCRIPTION OF THE DRAWINGS

All other advantages and benefits will become clear for those ordinary skilled in the art by reading the following detailed description of preferred embodiments. Drawings are only used for the purpose of showing the preferred embodiments, rather than limiting the present invention. And in the entire drawings, the same components are marked with the same reference numerals. In the figures:

FIG. 1 is a flow chart of a production batch scheduling method based on improved variable neighborhood search and differential evolution algorithms provided by an embodiment of the present invention; and

FIG. 2 is a structural schematic diagram of a production batch scheduling system based on improved variable neighborhood search and differential evolution algorithms provided by an embodiment of the present invention.

### DETAILED DESCRIPTION OF THE PRESENT INVENTION

The technical solutions in the embodiments of the present invention are described clearly and completely below in combination with the drawings in the embodiments of the present invention. Apparently, the described embodiments are only part of embodiments of the present invention, rather than all of embodiments. Based on the embodiments of the present invention, all other embodiments obtained by those ordinary skilled in the art without contributing creative labor belong to the protection scope of the present invention.

The embodiments of the present invention consider the dynamically arrived differential workpiece, and a coordinated batch scheduling problem of production and transportation in case of a single machine of a manufacturer. An optimization objective is to minimize a manufacturing time span. According to the problem characteristics, an effective intelligent algorithm is designed to solve the combinational optimization problem and promote the production efficiency and transportation efficiency of an enterprise.

For the convenience of understanding, detailed description is firstly made below to the problem to be solved by the embodiments of the present invention. Specifically:

(1) the set of the production and processing workpieces is J={J₁, . . . , Jᵢ, . . . , Jₙ}, the processing time of the workpiece Jᵢ is marked as pₜ, the size is marked as sᵢ, and the arrival time is marked as rᵢ.

(2) A processing machine is a parallel batch processor with a capacity of C. When processing, the workpiece could be subject to group batching freely and processed on the processor in a batch form, with a regulation that the sum of the sizes of the workpieces in each batch shall not be greater than C.

(3) The arrival time of the batch is decided by the workpiece having the maximum arrival time in the batch, and the completion time of the batch is equal to the maximum completion time of all the workpieces in the batch. Once a specific batch is formed, the workpiece in the batch shall not be removed, and new workpieces shall not be added in the batch.

(4) After all batches are processed, the workpieces are delivered to the customer by a transport vehicle, provided that the transport vehicle has unlimited transportation capability.

(5) The objective to be optimized is a time span required from the start of processing of the workpeice to the delivery of the last workpiece to the customer.

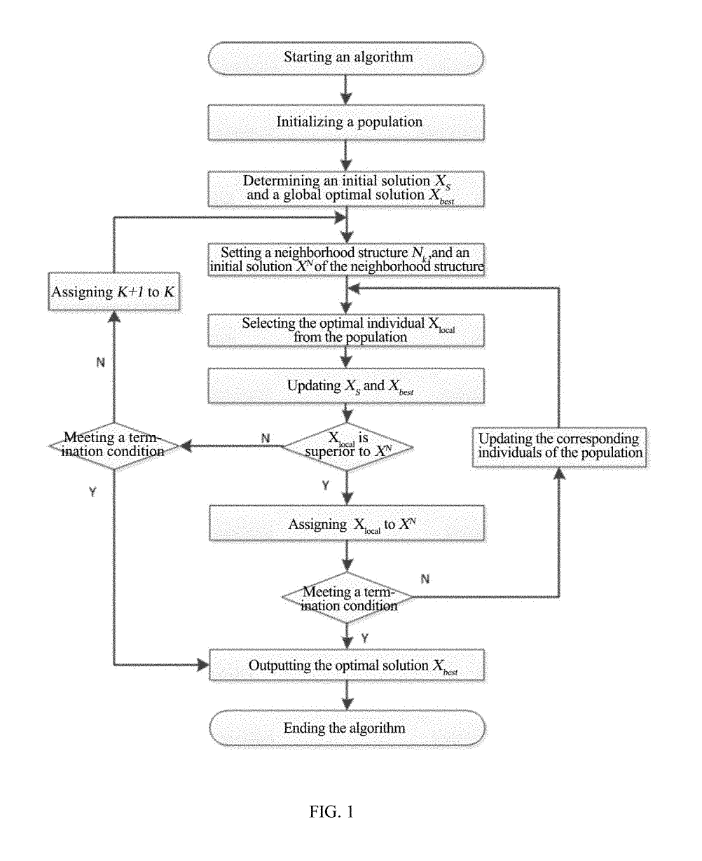

On this basis, an embodiment of the present invention provides a production batch scheduling method based on improved variable neighborhood search and differential evolution algorithms. The scheduling method is executed by a computer, and as shown in FIG. 1, includes:

S1. initializing an input parameter of an algorithm, including number n of workpieces, workpiece size s, a basic processing time p of the workpieces, an arrival time r of the workpieces, capacity C of a processing machine, and a time T of transporting the workpieces from a manufacturer to a customer. A set of processing workpieces is marked as J={J₁, . . . , Jᵢ, . . . , Jₙ}, wherein Jᵢ indicates the i-th workpiece;

S2. setting an execution parameter of the algorithm, wherein the execution parameter includes a maximum number of iterations Iₘₐₓ, a current number of iterations I=1, a population size Q, an initial solution Xₛ of the algorithm, number top of outstanding individuals in a population, and a global optimal solution X_{best}=Xₛ;

S3. setting a neighborhood structure N_{K}(X), wherein X indicates the initial solution, and K indicates a kind of the neighborhood structure. In consideration of three neighborhood structures, when K=1, it indicates variable neighborhood structure; when K=2, it indicates a cross neighborhood structure; and when K=3, it indicates an insertion neighborhood structure;

S4. initializing a population individual set S in a local search; and considering Q individuals totally, wherein the j-th individual in the I-th generation of populations is defined as Xⱼⁱ={xⱼ₁^{I}, xⱼ₂^{I}, . . . , x_{jd}^{I}, . . . , xⱼₙ^{I}}, 1≤I≤Iₘₐₓ, j=1,2, . . . , Q and d=1,2, . . . , n, wherein x_{jd}^{I}∈[1, n], indicating the x_{jd}-th workpiece in the workpiece set in the d-th position of the individual Xⱼ^{I};

S5. generating three initial individuals with three heuristic algorithms respectively, taking the initial solution as three individuals in the initial population, randomly generating the remaining individuals in the initial population, and selecting an optimal individual from the initial population as the initial solution;

S6. selecting the neighborhood structure, defining the initial solution Xₛ^{N} of the neighborhood structure, and performing a local search strategy to the individuals in the population in the neighborhood structure, to improve the quality of the population individuals;

S7. calculating a fitness value of each individual in the population respectively, thereby obtaining an individual X_{local} having the minimum fitness value from the population;

S8. updating the global optimal solution of the algorithm, judging whether F(X_{local})<F(X_{best}) is satisfied, and assigning X_{local} to X_{best} if so, wherein F(X) indicates the fitness value of the individual X;

S9. updating the initial solution, judging whether F(X_{local})<F(Xₛ) is satisfied, and assigning X_{local} to Xₛ if so;

S10. updating the initial solution of the neighborhood structure, judging whether F(X_{local})<F(Xₛ^{N}) is satisfied, and assigning X_{local} to Xₛ^{N} if so;

S11. assigning I+1 to I, judging whether I≤Iₘₐₓ is satisfied, performing step S12 if so, otherwise, performing step S13;

S12. judging whether Xₛ^{N} is updated, returning to step S6 if so, otherwise, assigning K+1 to K; and if K>3, setting K=1, and returning to step S6; and

S13. completing the execution of the algorithm and outputting the fitness value of the global optimal solution X_{best} and a group batching scheme corresponding to the workpiece.

The embodiment of the present invention can obtain an approximate optimal solution in regard to a coordinated batch scheduling problem of production and transportation in the case of a manufacturer single machine based on a differential workpiece, so that an enterprise can make full use of production resources to the greatest extent, thereby reducing the production cost and improving enterprise service level and customer satisfaction level.

In specific implementation, the step of generating three initial individuals with three heuristic algorithms respectively, taking the initial solution as three individuals in the initial population, randomly generating the remaining individuals in the initial population, and selecting an optimal individual from the initial population as the initial solution in step S5 may include:

step S51: defining a variable j=1;

step S52: judging a value of the variable j, and performing step S53 when the value is equal to 1; performing step S54 when the value is equal to 2; performing step S55 when the value is equal to 3; and performing step S56 when the variable has other values;

step S53: sorting all workpieces in the workpiece set J={J₁, . . . , Jᵢ, . . . , Jₙ} according to the arrival times thereof in a non-decreasing manner, and taking the sorted workpiece set J′ as the individual Xⱼ¹ in the initial population;

step S54: sorting all workpieces in the workpiece set J={J₁, . . . , Jᵢ, . . . , Jₙ} according to the processing times thereof in a non-decreasing manner, and taking the sorted workpiece set J′ as the individual Xⱼ¹ in the initial population;

step S55: sorting all workpieces in the workpiece set J={J₁, . . . , Jᵢ, . . . , Jₙ} according to the processing times thereof in a non-increasing manner, and taking the sorted workpiece set J′ as the individual Xⱼ¹ in the initial population;

step S56: sorting all workpieces in the workpiece set J={J₁, . . . , Jᵢ, . . . , Jₙ} randomly, and taking the sorted workpiece set J′ as the individual Xⱼ¹ in the initial population;

step S57: assigning j+1 to j, judging whether j≤Q is satisfied, returning to step S52 if so, otherwise, completing the population initialization; and

step S58: selecting the individual having the best quality according to the initial population, and assigning the individual to the initial solution Xₛ.

In specific implementation, the step of selecting the neighborhood structure in step S6 may include:

step S61: defining variables Xₜₑₘₚ and Xₛ^{N}, wherein the meanings of all elements of the two variables are the same as those of the initial solution Xₛ; and assigning Xₛ to Xₜₑₘₚ;

step S62: judging a value of a variable K, performing step S63 if the value is equal 1; performing step S64 if the value is equal to 2; and performing step S65 if the value is equal to 3;

step S63: defining a variable x′, randomly selecting an element x_{random} in Xₜₑₘₚ, assigning the value of x_{random} to x′, randomly generating an integer m within a range [1, n], replacing the value of x_{random} with m, and meanwhile, replacing the value in Xₜₑₘₚ and another element value which is the same as m with x′;

step S64: selecting two elements in Xₜₑₘₚ randomly, and exchanging the two elements;

step S65: selecting two elements in Xₜₑₘₚ randomly, and inserting one element into a next position of the other element; and

step S66: assigning transformed Xₜₑₘₚ to Xₛ^{N}, as the initial solution of the neighborhood structure.

In specific embodiment, the step of performing a local search strategy to the individuals in the population in the neighborhood structure in step S6 may include:

step S61′: defining that a variable Sₜₒₚ^{I} indicates the individual with top quality of the stored population quality, Nₒₜₕₑᵣ indicates the number of other remaining individuals of the population S^{I}, Sₗₑₐₛₜ^{I} indicates a set of other remaining individuals of the stored population S^{I}, N_{c} indicates the number of variation individuals, Nᵣ indicates the number of random individuals, and Sᵣ^{I} indicates a set of the stored random individuals;

step S62′: with regard to the population S^{I-1}, assigning the individual with top fitness in the population to Sₜₒₚ^{I}, and assigning the remaining individuals to Sₗₑₐₛₜ^{I};

step S63′: taking a remainder obtained by dividing the number of iterations I by Nₒₜₕₑᵣ, assigning the remainder to N_{c}, and setting N_{c}=1 if N_{c}=0;

step S64′: selecting an individual from Sₗₑₐₛₜ^{I}, randomly, generating two positions rand1 and rand2 randomly with regard to the individual, and rand1≠rand2, and performing symmetric exchange processing to an element of the individual between the two positions;

step S65′: repeating step S64′, until selecting N_{c} different individuals for corresponding variation operation;

step S66′: judging whether the current generation of neighborhood structure is the same as that of the previous generation, generating Nᵣ individuals randomly if so, and storing in Sᵣ, otherwise, performing step S67′;

step S67′: randomly selecting two elements in the initial solution Xₛ^{N} of the neighborhood structure, exchanging the two elements to generate a new individual, repeating such operation until generating Nᵣ individuals, and storing the individuals in S^{r}; and

step S68′: assigning all individuals in Sₜₒₚ^{I}, S^{c} and S^{r} to S^{I} respectively, as the regenerated population of this generation.

In specific embodiment, the step of calculating the fitness value of the individual in step S7 may include:

step S71: placing the first undistributed workpiece in a workpiece sequence of the individual X in the first existing batch capable of accommodating the workpiece, creating a new batch with a capacity of C if each existing batch cannot accommodate the workpiece, and placing the workpiece in the new batch;

step S72: repeating step S71, until all workpieces in the individual X are distributed to the corresponding batch, and obtaining a workpiece batch set B={B₁, . . . , Bᵢ, . . . , Bₗ}, wherein l indicates the number of the batches;

step S73: sorting the workpiece batches in the batch set obtained in step S72 according to the arrival times of the workpiece batches in a non-decreasing manner, and obtaining a sorted batch set B′={B′₁, . . . , B′ᵢ, . . . , B′ₗ}, wherein B′ᵢ indicates the workpiece batch processed in the l-th position in a processing machine;

step S74: defining a variable Cₘₐₓ=0, which indicates a time required by a manufacturing span, circulating a variable j=1, and marking the processing time of the workpiece batch B′ᵢ in the batch set B′ as Pᵢ^{B′} and the arrival time as rᵢ^{B′};

step S75: judging whether the current Cₘₐₓ≤rⱼ^{B′} is satisfied, assigning rⱼ^{B′}+Pⱼ^{B′} to Cₘₐₓ if so, otherwise, assigning Cₘₐₓ+Pⱼ^{B′} to Cₘₐₓ;

step S76: assigning j+1 to j, judging whether j≤l is satisfied, returning to step S75 if so, otherwise, assigning Cₘₐₓ+T to Cₘₐₓ; and

step S77: taking Cₘₐₓ value finally obtained in step S76 as the fitness value of the individual X.

The present invention has beneficial effects as follows:

1. With regard to the coordinated batch scheduling problem of production and transportation in the case of the single machine, the present invention firstly encodes the workpieces to be processed through the improved variable neighborhood search algorithm, distributes the workpieces to the corresponding batch according to a batching strategy (i.e., a scheduling scheme), and obtains the fitness value of the corresponding individual. The quality of the population is continuously improved by selecting the searched neighborhood structure, performing the local search in the neighborhood structure, and searching the population via operation, such as cross and reservation. The optimal solution is finally obtained by iterating the above steps and searching in a solution space continuously. The improved variable neighborhood search algorithm represents good performance in a convergence speed and quality of searched solution. Through the algorithm designed in the present invention, the coordinated batch scheduling problem of production and transportation of the differential workpiece in the case of the single machine is solved, and the enterprise management level in the production and transportation is improved, so that the overall benefit of the enterprise at the two stages is improved.

2. When an initial population is generated, the present invention firstly generates the corresponding individual with a heuristic method, such as ERT, LPT and SPT, as the individual of the initial population, the remaining individuals of the initial population are randomly generated, and then, the best individual is selected from the initial population as the initial solution, thereby ensuring the quality of the initial population.

3. The present invention totally designs three neighborhood structures when setting the neighborhood structures, which are the variable neighborhood structure, the cross neighborhood structure and the insertion neighborhood structure, thereby helping the algorithm to jump out of the local optimum in the search process, and avoiding the premature convergence of the algorithm.

4. When searching in neighborhood according to the present invention, the population is regenerated with the strategies such as reservation, cross and randomness, which not only guarantees the population diversity, but also inherits the outstanding individuals, thereby guaranteeing the quality of the individuals of the population all the time, and effectively improving the search efficiency of the improved algorithm.

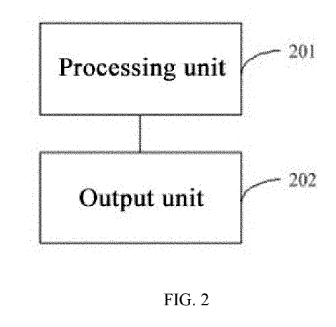

Based on the same inventive concept, another embodiment of the present invention provides a production batch scheduling system based on improved variable neighborhood search and differential evolution algorithms. As shown in FIG. 2, the system includes a computer, and the computer includes:

at least one processing unit 201;

at least one output unit 202; and

at least one storage unit (not shown in the figure),

wherein the processing unit is, for example, a processor; the storage unit is, for example, a memory; and the output unit is, for example, a data interface and an output device formed by a data line. The output unit may output the output data to a display screen, other electronic devices, etc.

The at least one storage unit stores at least one instruction, and the at least one instruction is loaded and executed by the at least one processing unit 201 to realize the following steps:

S1. initializing an input parameter of an algorithm, including number n of workpieces, workpiece size s, a basic processing time p of the workpieces, an arrival time r of the workpieces, capacity C of a processing machine, and a time T of transporting the workpieces from a manufacturer to a customer. A set of processing workpieces is marked as J={J₁, . . . , Jᵢ, . . . , Jₙ}, wherein Jᵢ indicates the i-th workpiece;

S2. setting an execution parameter of the algorithm, wherein the execution parameter includes a maximum number of iterations Iₘₐₓ, a current number of iterations I=1, a population size Q, an initial solution Xₛ of the algorithm, number top of outstanding individuals in a population, and a global optimal solution X_{best}=Xₛ;

S3. setting a neighborhood structure N_{K}(X), wherein X indicates the initial solution, and K indicates a kind of the neighborhood structure. In consideration of three neighborhood structures, when K−1, it indicates variable neighborhood structure; when K=2, it indicates a cross neighborhood structure; and when K=3, it indicates an insertion neighborhood structure;

S4. initializing a population individual set s in a local search; and considering individuals totally, wherein the j-th individual in the I-th generation of populations is defined as Xⱼ¹={xⱼ₁^{I}, xⱼ₂^{I}, . . . , x_{jd}^{I}, . . . , xⱼₙ^{I}}, 1≤I≤Iₘₐₓ, j=1,2, . . . , Q and d=1,2, . . . , n wherein x_{jd}^{I}∈[1, n], indicating the x_{jd}^{I}-th workpiece in the workpiece set in the d-th position of the individual Xⱼ^{I};

S5. generating three initial individuals with three heuristic algorithms respectively, taking the initial solution as three individuals in the initial population, randomly generating the remaining individuals in the initial population, and selecting an optimal individual from the initial population as the initial solution;

S6. selecting the neighborhood structure, defining the initial solution Xₛ^{N} of the neighborhood structure, and performing a local search strategy to the individuals in the population in the neighborhood structure, to improve the quality of the population individuals;

S7. calculating a fitness value of each individual in the population respectively, thereby obtaining an individual X_{local} having the minimum fitness value from the population;

S8. updating the global optimal solution of the algorithm, judging whether F(X_{local})<F(X_{best}) is satisfied, and assigning X_{local} to X_{best} if so, wherein F(X) indicates the fitness value of the individual X;

S9. updating the initial solution, judging whether F(X_{local})<F(Xₛ) is satisfied, and assigning X_{local} to Xₛ if so;

S10. updating the initial solution of the neighborhood structure, judging whether F(X_{local})<F(Xₛ^{N}) is satisfied, and assigning X_{local} to Xₛ^{N} if so;

S11. assigning I+1 to I, judging whether I≤Iₘₐₓ is satisfied, performing step S12 if so, otherwise, performing step S13;

S12. judging whether Xₛ^{N} is updated, returning to step S6 if so, otherwise, assigning K+1 to K; and if K>3, setting K=1, and returning to step S6; and

S13. completing the execution of the algorithm.

The at least one output unit 202 is configured to output the fitness value of the global optimal solution X_{best} and a group batching scheme corresponding to the workpiece,

Optionally, the step of generating three initial individuals with three heuristic algorithms respectively, taking the initial solution as three individuals in the initial population, randomly generating the remaining individuals in the initial population, and selecting an optimal individual from the initial population as the initial solution in step S5 executed by the at least one processing unit 201 includes:

step S51: defining a variable J=1;

step S52: judging a value of the variable j, and performing step S53 when the value is equal to 1; performing step S54 when the value is equal to 2; performing step S55 when the value is equal to 3; and performing step S56 when the variable has other values;

step S53: sorting all workpieces in the workpiece set J={J₁, . . . , Jᵢ, . . . , Jₙ} according to the arrival times thereof in a non-decreasing manner, and taking the sorted workpiece set J′ as the individual Xⱼ¹ in the initial population;

step S54: sorting all workpieces in the workpiece set J={J₁, . . . , Jᵢ, . . . , Jₙ} according to the processing times thereof in a non-decreasing manner, and taking the sorted workpiece set J′ as the individual Xⱼ¹ in the initial population;

step S55: sorting all workpieces in the workpiece set J={J₁, . . . , Jᵢ, . . . , Jₙ} according to the processing times thereof in a non-increasing manner, and taking the sorted workpiece set J′ as the individual Xⱼ¹ in the initial population;

step S56: sorting all workpieces in the workpiece set J={J₁, . . . , Jᵢ, . . . , Jₙ} randomly, and taking the sorted workpiece set J′ as the individual Xₛ¹ in the initial population;

step S57: assigning j+1 to j, judging whether j≤Q is satisfied, returning to step S52 if so, otherwise, completing the population initialization; and

step S58: selecting the individual having the best quality according to the initial population, and assigning the individual to the initial solution Xₛ.

Optionally, the step of selecting the neighborhood structure in step S6, executed by the at least one processing unit 201, includes:

step S61: defining variables Xₜₑₘₚ and Xₛ^{N}, wherein the meanings of all elements of the two variables are the same as those of the initial solution Xₛ; and assigning Xₛ to Xₜₑₘₚ;

step S62: judging a value of a variable K, performing step S63 if the value is equal 1; performing step S64 if the value is equal to 2; and performing step S65 if the value is equal to 3;

step S63: defining a variable x′, randomly selecting an element x_{random} in Xₜₑₘₚ, assigning the value of x_{random} to x′, randomly generating an integer m within a range [1, n], replacing the value of x_{random} with m, and meanwhile, replacing the value in Xₜₑₘₚ and another element value which is the same as m with x;

step S64: selecting two elements in Xₜₑₘₚ randomly, and exchanging the two elements;

step S65: selecting two elements in Xₜₑₘₚ randomly, and inserting one element into a next position of the other element; and

step S66: assigning transformed Xₜₑₘₚ to Xₛ^{N}, as the initial solution of the neighborhood structure.

Optionally, the step of performing a local search strategy to the individuals in the population in the neighborhood structure in step S6, executed by the at least one processing unit 201, includes:

step S61′: defining that a variable Sₜₒₚ^{I} indicates the individual with top quality of the stored population quality, Nₒₜₕₑᵣ indicates the number of other remaining individuals of the population S^{I}, Sₗₑₐₛₜ^{I} indicates a set of other remaining individuals of the stored population S^{I}, N_{c} indicates the number of variation individuals, Nᵣ indicates the number of random individuals, and Sᵣ^{I} indicates a set of the stored random individuals;

step S62′: with regard to the population S^{I-1}, assigning the individual with top fitness in the population to Sₜₒₚ^{I} and assigning the remaining individuals to Sₗₑₐₛₜ^{I};

step S63′: taking a remainder obtained by dividing the number of iterations I by Nₒₜₕₑᵣ, assigning the remainder to N_{c}, and setting N_{c}−1 if N_{c}−0;

step S64′: selecting an individual from Sₗₑₐₛₜ^{I} randomly, generating two positions rand1 and rand2 randomly with regard to the individual, and rand1≠rand2, and performing symmetric exchange processing to an element of the individual between the two positions;

step S65′: repeating step S64′, until selecting N_{c} different individuals for corresponding variation operation;

step S66′: judging whether the current generation of neighborhood structure is the same as that of the previous generation, generating Nᵣ individuals randomly if so, and storing in S^{r}, otherwise, performing step S67′;

step S67′: randomly selecting two elements in the initial solution Xₛ^{N} of the neighborhood structure, exchanging the two elements to generate a new individual, repeating such operation until generating Nᵣ individuals, and storing the individuals in S^{r}; and

step S68′: assigning all individuals in Sₜₒₚ^{I}, S^{c} and S^{r} to S^{I} respectively, as the regenerated population of this generation.

Optionally, the step of calculating the fitness value of the individual in step S7, executed by the at least one processing unit 201, includes:

step S71: placing the first undistributed workpiece in a workpiece sequence of the individual X in the first existing batch capable of accommodating the workpiece, creating a new batch with a capacity of C if each existing batch cannot accommodate the workpiece, and placing the workpiece in the new batch;

step S72: repeating step S71, until all workpieces in the individual X are distributed to the corresponding batch, and obtaining a workpiece batch set B={B₁, . . . , Bᵢ, . . . , Bₗ}, wherein l indicates the number of the batches;

step S73: sorting the workpiece batches in the batch set obtained in step S72 according to the arrival times of the workpiece batches in a non-decreasing manner, and obtaining a sorted batch set B′={B′₁, . . . , B′ᵢ, B′ₗ}, wherein B′ₗ indicates the workpiece batch processed in the l-th position in a processing machine;

step S74: defining a variable Cₘₐₓ=0, which indicates a time required by a manufacturing span, circulating a variable j=1, and marking the processing time of the workpiece batch B′ᵢ in the batch set B as Pᵢ^{B′} and the arrival time as rᵢ^{B′};

step S75: judging whether the current Cₘₐₓ≤rⱼ^{B′} is satisfied, assigning rⱼ^{B′}|Pⱼ^{B′} to Cₘₐₓ if so, otherwise, assigning Cₘₐₓ+Pⱼ^{B′} to Cₘₐₓ;

step S76: assigning j+1 to j, judging whether j<l is satisfied, returning to step S75 if so, otherwise, assigning CₘₐₓT to Cₘₐₓ; and

step S77: taking Cₘₐₓ value finally obtained in step S76 as the fitness value of the individual X.

The production batch scheduling system based on improved variable neighborhood search and differential evolution algorithms, introduced by the present embodiment, is a system that could perform the production batch scheduling method based on improved variable neighborhood search and differential evolution algorithms in the embodiment of the present invention. Therefore, on the basis of the production batch scheduling method based on improved variable neighborhood search and differential evolution algorithms introduced in the embodiment of the present invention, those skilled in the art can know the specific implementation of the production batch scheduling system based on improved variable neighborhood search and differential evolution algorithms in the present embodiment and various variation forms. Therefore, no detailed introduction is given to the point on how the production batch scheduling system based on improved variable neighborhood search and differential evolution algorithms realizes the production batch scheduling method based on improved variable neighborhood search and differential evolution algorithms in the embodiment of the present invention. As long as those skilled in the art implement the system adopted by the production batch scheduling method based on improved variable neighborhood search and differential evolution algorithms in the embodiment of the present invention, such system belongs to the scope to be protected by the present application.

An embodiment of the present invention further provides a computer readable storage medium. The storage medium stores at least one instruction which is loaded and executed by a processor to realize the above scheduling method.

A lot of specific details are made in the description provided herein. However, it could be understood that, the embodiment of the present invention could be practiced without the specific details. In some examples, known methods, structures and technologies are not shown in detail, so as to avoid confusing the understanding of this description.

Similarly, it should be understood that, to simplify the present disclosure and help to understand one or more of aspects of the present invention, all features of the present invention are sometimes grouped into a single embodiment, figure or description for such features in the above description for the exemplary embodiment of the present invention. However, the method of the disclosure should not be interpreted to reflect the following intention: the present invention to be protected requires more features than those clearly recorded in each claim. More specifically, as reflected in the claims below, the aspects of the present invention are less than all features of the single embodiment disclosed previously. Therefore, the claims following the specific embodiment are specifically incorporated into the specific embodiment, wherein each of the claims is taken as a separate embodiment of the present invention.

What is claimed is:

1. A production batch scheduling method based on improved variable neighborhood search and differential evolution algorithms, executed by a computer and comprising:
S1. initializing an input parameter of an algorithm, comprising number n of workpieces, workpiece size s, a basic processing time p of the workpieces, an arrival time r of the workpieces, capacity C of a processing machine, and a time T of transporting the workpieces from a manufacturer to a customer, wherein a set of processing workpieces is marked as J={J₁, . . . , Jᵢ, . . . , Jₙ} and Jᵢ indicates the i-th workpiece;
S2. setting an execution parameter of the algorithm, wherein the execution parameter comprises a maximum number of iterations Iₘₐₓ, a current number of iterations I−1, a population size Q, an initial solution Xₛ of the algorithm, number top of outstanding individuals in a population, and a global optimal solution X_{best}=Xₛ;
S3. setting a neighborhood structure N_{K}(X), wherein X indicates the initial solution, and K indicates a kind of the neighborhood structure; in consideration of three neighborhood structures, when K=1, it indicates a variable neighborhood structure; when K=2, it indicates a cross neighborhood structure; and when K=3, it indicates an insertion neighborhood structure;
S4. initializing a population individual set S in a local search; and considering Q individuals totally, wherein the j-th individual in the I-th generation of populations is defined as Xⱼ^{I}={xⱼ₁^{I}, xⱼ₂^{I}, . . . , x_{jd}^{I}, . . . , xⱼₙ^{I}}, 1≤I≤Iₘₐₓ, j=1,2, . . . ,Q and d=1,2, . . . , n, wherein x_{jd}^{I}∈[1, n], indicating the x_{jd}^{I}-th workpiece in the workpiece set in the d-th position of the individual Xⱼ^{I};
S5. generating three initial individuals with three heuristic algorithms respectively, taking the initial solution as three individuals in the initial population, randomly generating the remaining individuals in the initial population, and selecting an optimal individual from the initial population as the initial solution;
S6. selecting the neighborhood structure, defining the initial solution Xₛ^{N} of the neighborhood structure, and performing a local search strategy to the individuals in the population in the neighborhood structure, to improve the quality of the population individuals;
S7. calculating a fitness value of each individual in the population respectively, thereby obtaining an individual X_{local} having the minimum fitness value from the population;
S8. updating the global optimal solution of the algorithm, judging whether F(X_{local})<F(X_{best}) is satisfied, and assigning X_{local} to X_{best} if so, wherein F(X) indicates the fitness value of the individual X;
S9. updating the initial solution, judging whether F(X_{local})<F(Xₛ) is satisfied, and assigning X_{local} to Xₛ if so;
S10. updating the initial solution of the neighborhood structure, judging whether F(X_{local})<F(Xₛ^{N}) is satisfied, and assigning X_{local} to Xₛ^{N} if so;
S11. assigning I+1 to I, judging whether I≤Iₘₐₓ is satisfied, performing step S12 if so, otherwise, performing step S13;
S12. judging whether Xₛ^{N} is updated, returning to step S6 if so, otherwise, assigning K+1 to K; and if K>3, setting K=1, and returning to step S6; and
S13. completing the execution of the algorithm and outputting the fitness value of the global optimal solution X_{best} and a group batching scheme corresponding to the workpiece;
wherein the step of performing a local search strategy to the individuals in the population in the neighborhood structure in step S6 comprises:
step S61′: defining that a variable Sₜₒₚ^{I} indicates the individual with top quality of the stored population quality, Nₒₜₕₑᵣ indicates the number of other remaining individuals of the population S^{I}, Sₗₑₐₛₜ^{I} indicates a set of other remaining individuals of the stored population S_{I}, N_{c} indicates the number of variation individuals, Nᵣ indicates the number of random individuals, and Sᵣ^{I} indicates a set of the stored random individuals;
step S62′: with regard to the population S^{I-1}, assigning the individual with top fitness in the population to Sₜₒₚ^{I}, and assigning the remaining individuals to Sₗₑₐₛₜ^{I};
step S63′: taking a remainder obtained by dividing the number of iterations I by Nₒₜₕₑᵣ, assigning the remainder to N_{c}, and setting N_{c}−1 if N_{c}−0;
step S64′: selecting an individual from Sₗₑₐₛₜ^{I} randomly, generating two positions rand1 and rand2 randomly with regard to the individual, and rand1≠rand2, and performing symmetric exchange processing to an element of the individual between the two positions;
step S65′: repeating step S64′, until selecting N_{c} different individuals for corresponding variation operation;
step S66′: judging whether the current generation of neighborhood structure is the same as that of the previous generation, generating Nᵣ individuals randomly if so, and storing in S^{r}, otherwise, performing step S67′;
step S67′: randomly selecting two elements in the initial solution Xₛ^{N} of the neighborhood structure, exchanging the two elements to generate a new individual, repeating such operation until generating Nᵣ individuals, and storing the individuals in S^{r}; and
step S68′: assigning all individuals in Sₜₒₚ^{I}, S^{c} and S^{r} to S^{I} respectively, as the regenerated population of this generation,
wherein the step of generating three initial individuals with three heuristic algorithms respectively, taking the initial solution as three individuals in the initial population, randomly generating the remaining individuals in the initial population, and selecting an optimal individual from the initial population as the initial solution in step S5 comprises:
step S51: defining a variable j=1;
step S52: judging a value of the variable j, and performing step S53 when the value is equal to 1; performing step S54 when the value is equal to 2; performing step S55 when the value is equal to 3; and performing step S56 when the variable has other values;
step S53: sorting all workpieces in the workpiece set J={J₁, . . . , Jᵢ, . . . , Jₙ} according to the arrival times in a non-decreasing manner, and taking the sorted workpiece set J′ as the individual Xⱼ¹ in the initial population;
step S54: sorting all workpieces in the workpiece set J={J₁, . . . , Jᵢ, . . . , Jₙ} according to the processing times in a non-decreasing manner, and taking the sorted workpiece set J′ as the individual Xⱼ¹ in the initial population;
step S55: sorting all workpieces in the workpiece set J={J₁, . . . , Jᵢ, . . . , Jₙ} according to the processing times in a non-increasing manner, and taking the sorted workpiece set J′ as the individual Xⱼ¹ in the initial population;
step S56: sorting all workpieces in the workpiece set J={J₁, . . . , Jᵢ, . . . , Jₙ} randomly, and taking the sorted workpiece set J′ as the individual Xⱼ¹ in the initial population;
step S57: assigning j+1 to j, judging whether j≤Q is satisfied, returning to step S52 if so, otherwise, completing the population initialization; and
step S58: selecting the individual having the best quality according to the initial population, and assigning the individual to the initial solution Xₛ,
wherein the step of calculating the fitness value of the individual in step S7 comprises:
step S71: placing the first undistributed workpiece in a workpiece sequence of the individual X in the first existing batch capable of accommodating the workpiece, creating a new batch with a capacity of C if each existing batch cannot accommodate the workpiece, and placing the workpiece in the new batch;
step S72: repeating step S71, until all workpieces in the individual X are distributed to the corresponding batch, and obtaining a workpiece batch set B={B₁, . . . , Bᵢ, . . . , Bₗ}, wherein l indicates the number of the batches;
step S73: sorting the workpiece batches in the batch set obtained in step S72 according to the arrival times of the workpiece batches in a non-decreasing manner, and obtaining a sorted batch set B′={B′₁, . . . , B′ᵢ, . . . , B′ₗ}, wherein B′ᵢ indicates the workpiece batch processed in the l-th position in a processing machine;
step S74: defining a variable Cₘₐₓ=0, which indicates a time required by a manufacturing span, circulating a variable j=1, and marking the processing time of the workpiece batch B′ᵢ in the batch set B′ as Pᵢ^{B} and the arrival time as rᵢ^{B′};
step S75: judging whether the current Cₘₐₓ≤rⱼ^{B′} is satisfied, assigning rⱼ^{B′}+Pⱼ^{B′} to Cₘₐₓ if so, otherwise, assigning Cₘₐₓ+Pⱼ^{B′} to Cₘₐₓ;
step S76: assigning j+1 to j, judging whether j≤l is satisfied, returning to step S75 if so, otherwise, assigning Cₘₐₓ+T to Cₘₐₓ; and
step S77: taking max value finally obtained in step S76 as the fitness value of the individual X.

2. The method according to claim 1, wherein the step of selecting the neighborhood structure in step S6 comprises:
step S61: defining variables Xₜₑₘₚ and Xₛ^{N}, wherein the meanings of all elements of the two variables are the same as those of the initial solution Xₛ; and assigning Xₛ to Xₜₑₘₚ;
step S62: judging a value of a variable K, performing step S63 if the value is equal 1; performing step S64 if the value is equal to 2; and performing step S65 if the value is equal to 3;
step S63: defining a variable x′, randomly selecting an element x_{random} in Xₜₑₘₚ, assigning the value of x_{random} to x, randomly generating an integer m within a range [1, n], replacing the value of x_{random} with m, and meanwhile, replacing the value in Xₜₑₘₚ and another element value which is the same as m with x′;
step S64: selecting two elements in Xₜₑₘₚ randomly, and exchanging the two elements;
step S65: selecting two elements in Xₜₑₘₚ randomly, and inserting one element into a next position of the other element; and
step S66: assigning transformed Xₜₑₘₚ to Xₛ^{N}, as the initial solution of the neighborhood structure.

3. A production batch scheduling system based on improved variable neighborhood search and differential evolution algorithms, wherein the scheduling system comprises a computer, and the computer comprises:
at least one storage unit;
at least one processing unit; and
at least one output unit,
wherein the at least one storage unit stores at least one instruction, and the at least one instruction is loaded and executed by the at least one processing unit to realize the following steps:
S1. initializing an input parameter of an algorithm, comprising number n of workpieces, workpiece size s, a basic processing time p of the workpieces, an arrival time r of the workpieces, capacity C of a processing machine, and a time T of transporting the workpieces from a manufacturer to a customer, wherein a set of processing workpieces is marked as J={J₁, . . . , Jᵢ, . . . , Jₙ} and Jᵢ indicates the i-th workpiece;
S2. setting an execution parameter of the algorithm, wherein the execution parameter comprises a maximum number of iterations Iₘₐₓ, a current number of iterations I−1, a population size Q, an initial solution Xₛ of the algorithm, number top of outstanding individuals in a population, and a global optimal solution X_{best}=Xₛ;
S3. setting a neighborhood structure N_{K}(X), wherein X indicates the initial solution, and K indicates a kind of the neighborhood structure; in consideration of three neighborhood structures, when K=1, it indicates variable neighborhood structure; when K=2, it indicates a cross neighborhood structure; and when K=3, it indicates an insertion neighborhood structure;
S4. initializing a population individual set S in a local search; and considering Q individuals totally, wherein the j-th individual in the I-th generation of populations is defined as Xⱼ^{I}={xⱼ₁^{I}, xⱼ₂^{I}, . . . , x_{jd}^{I}, . . . , xⱼₙ^{I}}, 1≤I≤Iₘₐₓ, j=1,2, . . . , Q and d=1,2, . . . , n, wherein x_{jd}^{I}∈[1, n], indicating the x_{jd}^{I}-th workpiece in the workpiece set in the d-th position of the individual Xⱼ^{I};
S5. generating three initial individuals with three heuristic algorithms respectively, taking the initial solution as three individuals in the initial population, randomly generating the remaining individuals in the initial population, and selecting an optimal individual from the initial population as the initial solution;
S6. selecting the neighborhood structure, defining the initial solution Xₛ^{N} of the neighborhood structure, and performing a local search strategy to the individuals in the population in the neighborhood structure, to improve the quality of the population individuals;
S7. calculating a fitness value of each individual in the population respectively, thereby obtaining an individual X_{local} having the minimum fitness value from the population;
S8. updating the global optimal solution of the algorithm, judging whether F(X_{local})<F(X_{best}) is satisfied, and assigning X_{local} to X_{best} if so, wherein F(X) indicates the fitness value of the individual X;
S9. updating the initial solution, judging whether F(X_{local})<F(Xₛ) is satisfied, and assigning X_{local} to Xₛ if so;
S10. updating the initial solution of the neighborhood structure, judging whether F(X_{local})<F(Xₛ^{N}) is satisfied, and assigning X_{local} to Xₛ^{N} if so;
S11. assigning I+1 to I , judging whether I≤Iₘₐₓ is satisfied, performing step S12 if so, otherwise, performing step S13;
S12. judging whether Xₛ^{N} is updated, returning to step S6 if so, otherwise, assigning K+1 to K; and if K>3, setting K=1, and returning to step S6; and
S13. completing the execution of the algorithm;
the at least one output unit is configured to output the fitness value of the global optimal solution X_{best} and a group batching scheme corresponding to the workpiece,
wherein the process of performing a local search strategy to the individuals in the population in the neighborhood structure in step S6, realized by loading and executing the at least one instruction by the at least one processing unit, comprises:
step S61′: defining that a variable Sₜₒₚ^{I} indicates the individual with top quality of the stored population quality, Nₒₜₕₑᵣ indicates the number of other remaining individuals of the population S^{I}, Sₗₑₐₛₜ^{I} indicates a set of other remaining individuals of the stored population S^{I}, N_{c} indicates the number of variation individuals, Nᵣ indicates the number of random individuals, and Sᵣ^{I} indicates a set of the stored random individuals;
step S62′: with regard to the population S^{I-1}, assigning the individual with top fitness in the population to Sₜₒₚ^{I}, and assigning the remaining individuals to Sₗₑₐₛₜ^{I};
step S63′: taking a remainder obtained by dividing the number of iterations I by Nₒₜₕₑᵣ, assigning the remainder to N_{c}, and setting N_{c}=1 if N_{c}=0;
step S64′: selecting an individual from Sₗₑₐₛₜ^{I} randomly, generating two positions rand1 and rand2 randomly with regard to the individual, and rand1≠rand2, and performing symmetric exchange processing to an element of the individual between the two positions;
step S65′: repeating step S64′, until selecting N_{c} different individuals for corresponding variation operation;
step S66′: judging whether the current generation of neighborhood structure is the same as that of the previous generation, generating Nᵣ individuals randomly if so, and storing in S^{r}, otherwise, performing step S67′;
step S67′: randomly selecting two elements in the initial solution Xₛ^{N} of the neighborhood structure, exchanging the two elements to generate a new individual, repeating such operation until generating Nᵣ individuals, and storing the individuals in S^{r}; and
step S68′: assigning all individuals in Sₜₒₚ^{I} S^{c} and S^{r} to S^{I} respectively, as the regenerated population of this generation,
wherein the step of generating three initial individuals with three heuristic algorithms respectively, taking the initial solution as three individuals in the initial population, randomly generating the remaining individuals in the initial population, and selecting an optimal individual from the initial population as the initial solution in step S5, realized by loading and executing the at least one instruction by the at least one processing unit, comprises:
step S51: defining a variable j=1;
step S52: judging a value of the variable j, and performing step S53 when the value is equal to 1; performing step S54 when the value is equal to 2; performing step S55 when the value is equal to 3; and performing step S56 when the variable has other values;
step S53: sorting all workpieces in the workpiece set J={J₁, . . . , Jᵢ, . . . , Jₙ} according to the arrival times in a non-decreasing manner, and taking the sorted workpiece set J′ as the individual Xⱼ¹ in the initial population;
step S54: sorting all workpieces in the workpiece set J={J₁, . . . , Jᵢ, . . . , Jₙ} according to the processing times in a non-decreasing manner, and taking the sorted workpiece set J′ as the individual Xⱼ¹ in the initial population;
step S55: sorting all workpieces in the workpiece set J={J₁, . . . , Jᵢ, . . . , Jₙ} according to the processing times in a non-increasing manner, and taking the sorted workpiece set J′ as the individual Xⱼ¹ in the initial population;
step S56: sorting all workpieces in the workpiece set J={J₁, . . . , Jᵢ, . . . , Jₙ} randomly, and taking the sorted workpiece set, J′ as the individual Xⱼ¹ in the initial population;
step S57: assigning j+1 to j, judging whether j≤Q is satisfied, returning to step S52 if so, otherwise, completing the population initialization; and
step S58: selecting the individual having the best quality according to the initial population, and assigning the individual to the initial solution Xₛ,
wherein the process of calculating the fitness value of the individual in step S7, realized by loading and executing the at least one instruction by the at least one processing unit, comprises:
step S71: placing the first undistributed workpiece in a workpiece sequence of the individual X in the first existing batch capable of accommodating the workpiece, creating a new batch with a capacity of C if each existing batch cannot accommodate the workpiece, and placing the workpiece in the new batch;
step S72: repeating step S71, until all workpieces in the individual X are distributed to the corresponding batch, and obtaining a workpiece batch set B={B₁, . . . , Bᵢ, . . . , Bₗ}, wherein l indicates the number of the batches;
step S73: sorting the workpiece batches in the batch set obtained in step S72 according to the arrival times of the workpiece batches in a non-decreasing manner, and obtaining a sorted batch set B′={B′₁, . . . , B′ᵢ, . . . , B′ₗ}, wherein B′ᵢ indicates the workpiece batch processed in the l-th position in a processing machine;
step S74: defining a variable Cₘₐₓ=0, which indicates a time required by a manufacturing span, circulating a variable j=1, and marking the processing time of the workpiece batch B′ᵢ in the batch set B′ as Pᵢ^{B′} and the arrival time as rⱼ^{B′};
step S75: judging whether the current Cₘₐₓ≤rⱼ^{B′} is satisfied, assigning rⱼ^{B′}|Pⱼ^{B′} to Cₘₐₓ if so, otherwise, assigning Cₘₐₓ+Pⱼ^{B′} to Cₘₐₓ;
step S76: assigning j+1 to j, judging whether j≤l is satisfied, returning to step S75 if so, otherwise, assigning Cₘₐₓ+T to Cₘₐₓ; and
step S77: taking Cₘₐₓ value finally obtained in step S76 as the fitness value of the individual X.

4. The system according to claim 3, wherein the process of selecting the neighborhood structure in step S6, realized by loading and executing the at least one processing unit by the at least one instruction comprises:
step S61: defining variables Xₜₑₘₚ and Xₛ^{N}, wherein the meanings of all elements of the two variables are the same as those of the initial solution Xₛ; and assigning Xₛ to Xₜₑₘₚ;
step S62: judging a value of a variable K, performing step S63 if the value is equal 1; performing step S64 if the value is equal to 2; and performing step S65 if the value is equal to 3;
step S63: defining a variable x′, randomly selecting an element X_{random} in Xₜₑₘₚ, assigning the value of x_{random} to x′, randomly generating an integer m within a range [1, n], replacing the value of x_{random}, with m , and meanwhile, replacing the value in Xₜₑₘₚ and another element value which is the same as m with x′;
step S64: selecting two elements in Xₜₑₘₚ randomly, and exchanging the two elements;
step S65: selecting two elements in Xₜₑₘₚ randomly, and inserting one element into a next position of the other element; and
step S66: assigning transformed Xₜₑₘₚ to Xₛ^{N}, as the initial solution of the neighborhood structure.

5. A computer readable storage medium, storing at least one instruction which is loaded and executed by a processor to realize the method of claim 1.
